(19) United States
(12) Patent Application Publication
(10) Pub. No.: US 2007/0228981 A1
(43) Pub. Date: Oct. 4, 2007

(54) Electrode for a Discharge Lamp and Discharge Lamp

(75) Inventors: Thomas Bittmann, Friedberg (DE); Bodo Mittler, Stadtbergen (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munich (DE)

(21) Appl. No.: 11/596,572

(22) PCT Filed: May 19, 2005
(86) PCT No.: PCT/DE05/00921

§ 371 Date: Nov. 15, 2006

(30) Foreign Application Priority Data
Jun. 15, 2004 (DE) 10 2004 028 562.4

(51) Int. Cl. H01J 61/04

(52) U.S. Cl. 313/631

(57) ABSTRACT

An electrode for a discharge lamp includes an elongate shank (11a) and a top (11b) that is arranged on one end of the shank (11a). The shaft (11a) is flattened to such an extent that its dimensions at an angle to is longitudinal extension are not larger than the corresponding transversal dimensions of the top (11b).

The invention relates to an electrode for a discharge lamp in accordance with the precharacterizing clause of patent claim 1 and a discharge lamp having such electrodes.

### I. PRIOR ART

Such an electrode and a discharge lamp having such an electrode are disclosed, for example, in the laid-open specification WO 03/060947 A2. This specification describes a two-part electrode having a cylindrical shaft and a cylindrical head, the shaft and the head of the electrode having different diameters and/or consisting of different materials. This electrode is used in a high-pressure discharge lamp for vehicle headlights.

### II. DESCRIPTION OF THE INVENTION

The object of the invention is to provide an improved electrode for discharge lamps. In particular, the electrode should be capable of being welded better to other metal parts.

This object is achieved according to the invention by the features of patent claims 1 and 8. Particularly advantageous refinements of the invention are described in the dependent patent claims.

The electrode according to the invention has an elongate shaft and a head, which is arranged at one end of the shaft, according to the invention the shaft being flattened such that its dimensions transversely with respect to its longitudinal extent are at most as large as the corresponding transverse dimensions of the head. The flattened shaft can be welded better to other metal parts, in particular to molybdenum fuse-sealing foils, since a larger surface is available for the welded joint in the region of the flattened section. In addition, the shaft has a lower mass than the head part per unit of length owing to the abovementioned dimensions and therefore also has a correspondingly lower thermal capacity, with the result that only a comparatively low quantity of energy in the form of heat is dissipated via the shaft from the discharge by the electrode according to the invention.

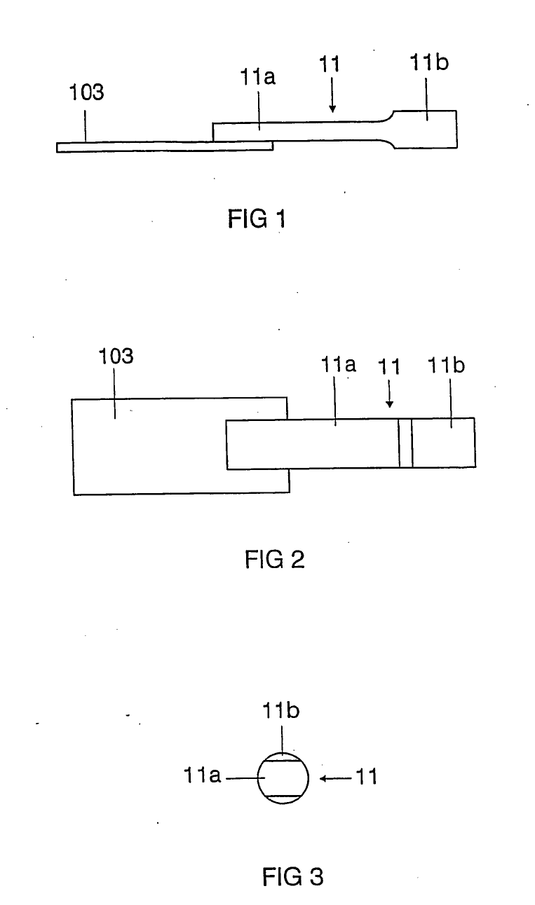

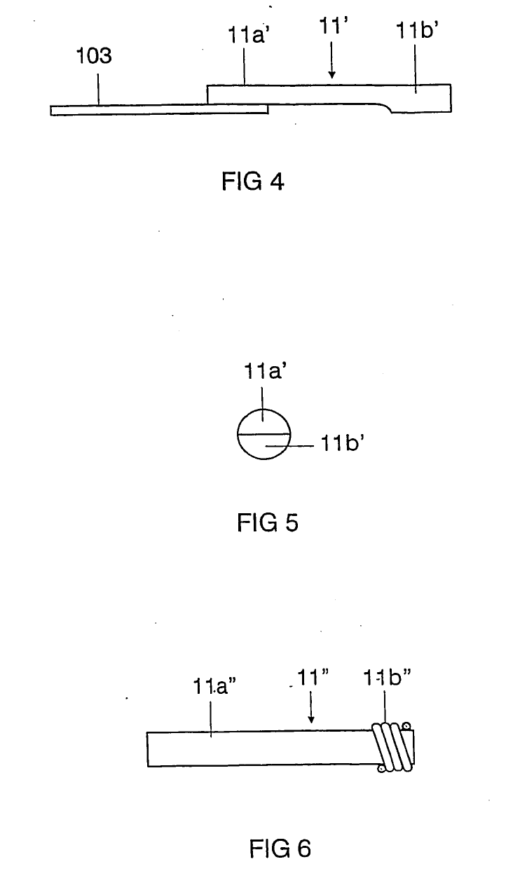

The electrode according to the invention is advantageously only flattened on one side or on two opposite sides for the purpose of simplifying its production. Flattening of the electrode in the region of the shaft is carried out by removing material by means of cutting, preferably by means of milling or grinding or by evaporating material, preferably by means of lasers. These methods have the advantage that the electrode according to the invention can also have an integral design in the region of the shaft and the head and, in particular, no welding between the shaft and the head is therefore required. As a result, the electrode according to the invention has improved mechanical robustness in comparison with a multi-part electrode. In order to ensure a high degree of rigidity of the electrode, the transition from the head to the shaft of the electrode according to the invention is advantageously designed to be as moderate as possible. In the illustration of the preferred exemplary embodiments shown in FIGS. 1 and 4, the transition is preferably formed by means of a radius, whose value is preferably in a range of from 0.3 mm to 0.5 mm.

The electrode according to the invention is preferably used as a gas-discharge electrode for discharge lamps, in particular high-pressure discharge lamps having a discharge vessel consisting of quartz glass which is provided with molybdenum foil seals. The dimension of the shaft of the electrode according to the invention preferably has a value in the range of from 50 μm to 350 μm along a first physical direction, which is oriented transversely with respect to the longitudinal direction of the electrode, and has a value in the range of from 200 μm to 450 μm along a second physical direction, which is oriented transversely with respect to the longitudinal direction of the electrode and at right angles to the first physical direction. Such electrodes are suitable for use in metal-halide high-pressure discharge lamps for motor vehicle headlights which have a comparatively low power consumption of approximately 35 watts. The electrode according to the invention preferably consists of tungsten, a tungsten alloy or of tungsten provided with dopants in order to be able to withstand the high temperatures of a gas discharge in a high-pressure discharge lamp. For manufacturing reasons, the electrode according to the invention is preferably in the form of a pin-type electrode.

The head of the electrode may be provided with a filament in order to increase the thermal capacity of the head. The entire shaft or a section of the shaft of the electrode according to the invention may be coated with ruthenium in order to reduce the risk of the occurrence of cracks or flaws in the region of the discharge vessel in which the shaft of the electrode is tightly embedded in the discharge vessel material.

### III. DESCRIPTION OF THE PREFERRED EXEMPLARY EMBODIMENT

The invention will be explained in more detail below with reference to a preferred exemplary embodiment. In the drawing:

FIG. 1 shows a side view of an electrode in accordance with the first exemplary embodiment of the invention and a molybdenum foil welded thereto, in a schematic illustration,

FIG. 2 shows a second side view of the electrode and molybdenum foil depicted in FIG. 1 in a view rotated through an angle of 90 degrees about the longitudinal axis of the electrode with respect to FIG. 1,

FIG. 3 shows a plan view of the front side of the shaft of the electrode illustrated in FIG. 1,

FIG. 4 shows a side view of an electrode in accordance with the second exemplary embodiment of the invention and a molybdenum foil welded thereto, in a schematic illustration,

FIG. 5 shows a second side view of the electrode and molybdenum foil depicted in FIG. 4 in a view rotated through an angle of 90 degrees about the longitudinal axis of the electrode with respect to FIG. 4,

FIG. 6 shows a side view of an electrode in accordance with a third exemplary embodiment of the invention, in a schematic illustration, and

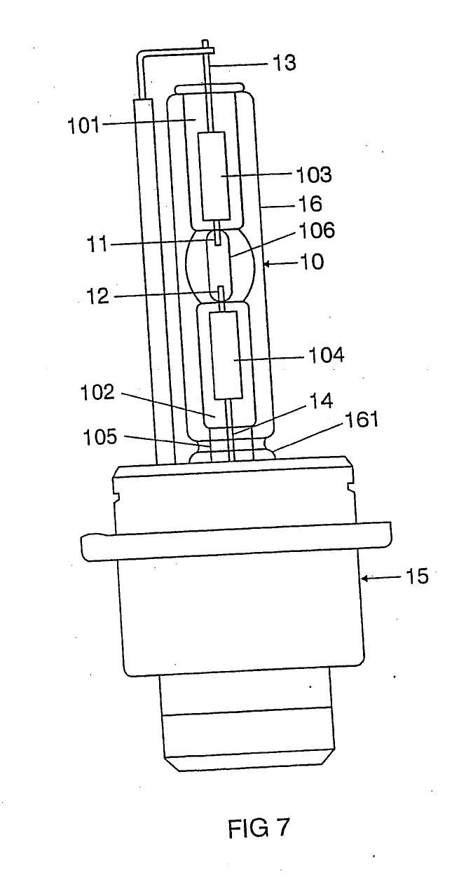

FIG. 7 shows a side view of a high-pressure discharge lamp having the electrodes according to the invention.

The electrodes illustrated schematically in FIGS. 1 to 6 and in accordance with the preferred exemplary embodiments of the invention are envisaged for use in the metal-halide high-pressure discharge lamp depicted schematically in FIG. 7.

The electrode 11 in accordance with the first exemplary embodiment of the invention is in the form of an integral pin or rod and consists of tungsten, which may have low quantities of the conventional dopants which are either advantageous for working the tungsten into rods or which improve the ability of the high-pressure discharge lamp to start, such as in the case of thorium oxide, for example. The electrode 11 has a shaft 11a and a head 11b. The head 11b is circular-cylindrical. It has a diameter of 0.35 mm. Its length is 1.2 mm. The shaft 11a has a length of 6.3 mm, with the result that the total length of the integral electrode 11 measures 7.5 mm overall. The shaft 11a is welded to a molybdenum foil 103, which serves the purpose of sealing the discharge vessel 10 of the high-pressure discharge lamp depicted in FIG. 7. The shaft 11a is designed to be flattened on two opposite sides, with the result that its transverse dimension at right angles to the molybdenum foil 103 is only 0.20 mm and is therefore smaller than the diameter of the head 11b. The transverse dimension of the shaft 11a parallel to the molybdenum foil 103 is 0.35 mm and therefore corresponds to the diameter of the head 11b. In order to produce the electrode 11, a tungsten rod is used whose transverse dimension in the region of the shaft 11a is adjusted to the desired value by mechanical removal of material on two sides, preferably by means of milling or grinding. As a result, the electrode 11 has an oval or rectangular cross section in the region of the shaft 11a. The surfaces of the shaft 11a which are produced owing to the flattening are particularly well suited for being welded to the molybdenum foil 103. Simplification of the production process of the electrodes according to the invention can be achieved by the electrode being flattened only on one side in the region of the shaft instead of on two sides, as is disclosed in the second exemplary embodiment of the invention and in FIGS. 4 and 5. The electrode 11′ in accordance with the second exemplary embodiment likewise consists of tungsten and has a total length of 7.5 mm. Its circular-cylindrical head 11b′ has a diameter of 0.35 mm and a length of 1.0 mm. The shaft 11a′ has a length of 7.5 mm and its transverse dimension at right angles to the molybdenum foil 103 is 0.20 mm, while its transverse dimension parallel to the molybdenum foil 103 corresponds to the diameter of the head 11b′. The electrode 11′, as in the first exemplary embodiment, is likewise produced from a circular-cylindrical pin or rod having a uniform diameter of 0.35 mm. The surface of the shaft 11a′ produced by the flattening of the electrode 11′ in the region of the shaft 11a′ is welded to the molybdenum foil 103, which serves the purpose of sealing the discharge vessel 10 of the high-pressure discharge lamp depicted in FIG. 7. Owing to the flattening on one side, the shaft 11a′ of the electrode 11′ has, in cross section at right angles to its longitudinal direction, a contour which is defined by a segment of a circle and a path in the form of a chord, as is illustrated schematically in FIG. 5.

The electrode 11″ in accordance with the third exemplary embodiment of the invention comprises a tungsten rod 11a″, which is flattened on two sides, and a tungsten filament 11b″, which is threaded onto one end of the tungsten rod 11a″ and forms the head 11b″ of the electrode 11″. The transverse dimension of the tungsten rod 11a″ at right angles to its surfaces produced by the flattening is 0.20 mm. Its transverse dimension parallel to these surfaces is 0.35 mm. The tungsten rod 11a″ has an oval or rectangular cross section at right angles to its longitudinal extent. That end of the electrode 11″ which is equipped with the filament 11b″ forms the discharge-side end of the electrode 11″ once it has been fitted in the discharge vessel 10 of the high-pressure discharge lamp. One of the surfaces of the tungsten rod 11a″ which are produced by the flattening is welded to the molybdenum foil 103 once the electrode 11″ has been fitted.

The high-pressure discharge lamp described in more detail below and depicted in FIG. 7 has two identical electrodes which correspond to one of the exemplary embodiments of the electrodes 11, 11′ or 11″ according to the invention described in more detail above.

The preferred exemplary embodiment of the invention is a mercury-free halogen metal-vapor high-pressure discharge lamp having an electrical power consumption of approximately 35 watts. This lamp is intended for use in a vehicle headlight. It has a discharge vessel 30 sealed on two sides, consisting of quartz glass and having a volume of 24 mm³, in which an ionizable filling is enclosed in a gas-tight manner. In the region of the discharge space 106, the inner contour of the discharge vessel 30 is circular-cylindrical and its outer contour is ellipsoidal. The inner diameter of the discharge space 106 is 2.6 mm and its outer diameter is 6.3 mm. The two ends 101, 102 of the discharge vessel 10 are each sealed off by means of a fused-in or pinched-in molybdenum foil 103, 104. The molybdenum foils 103, 104 each have a length of 6.5 mm, a width of 2 mm and a thickness of 25 μm. Two identical electrodes 11, 12 are located in the interior of the discharge vessel 10 and are formed so as to correspond to the above-explained first, second or third exemplary embodiment of the electrode 11, 11′ or 11″, and the discharge arc responsible for the emission of light is formed between them during lamp operation.

The distance between the electrodes 11, 12 is 4.1 mm. The electrodes 11, 12 are each electrically conductively connected to one electrical terminal of the lamp base 15, which essentially consists of plastic, via one of the molybdenum foils 103, 104 and via the power supply line 13 remote from the base or via the power return line 14 on the base side. The overlap B between the electrode 11 and the molybdenum foil 103 connected to it is 1.3 mm±0.15 mm. The discharge vessel 10 is surrounded by an outer bulb 16, which consists of quartz glass or hard glass. The quartz glass or hard glass of the outer bulb 16 is provided with the conventional additives absorbing UV radiation. The outer bulb 16 has a protrusion 161, which is anchored in the base 15. The outer diameter of the outer bulb 16 is 9 mm and its wall thickness is 0.9 mm. The discharge vessel 10 has a tubular extension 105 consisting of quartz glass on the base side, in which extension the power supply line 14 on the base side runs. The electrodes 11, 12, the molybdenum foils 103, 104 and/or power supply lines 13, 14 can be coated with ruthenium in the region of the sealed ends 101, 102 of the discharge vessel 10.

The ionizable filling enclosed in the discharge vessel consists of xenon having a coldfilling pressure of 11800 hPa, 0.25 mg sodium iodide, 0.18 mg scandium iodide, 0.03 mg zinc iodide and 0.0024 mg indium iodide. The operating voltage U of the lamp is 45 volts. Its color temperature is 4000 kelvin, and its color location is in the standard color table in accordance with DIN 5033 at the color coordinates x=0.383 and y=0.389. Its color rendering index is 65 and its luminous efficiency is 90 lm/W.

1. An electrode for a discharge lamp having an elongate shaft (11a) and a head (11b), which is arranged at one end of the shaft (11a), characterized in that the shaft (11a) is flattened such that its dimensions transversely with respect to its longitudinal extent are at most as large as the corresponding transverse dimensions of the head (11b).

2. The electrode as claimed in claim 1, characterized in that the electrode (11) has an integral design at least in the region of the shaft (11a) and the head (11b).

3. The electrode as claimed in claim 1, characterized in that the shaft (11a′) is flattened on one side.

4. The electrode as claimed in claim 1, characterized in that the shaft (11a) is flattened on two opposite sides.

5. The electrode as claimed in claim 1, characterized in that the dimension of the shaft (11a) has a value in the range of from 50 micrometers to 350 micrometers along a first physical direction, which is oriented transversely with respect to the longitudinal direction of the electrode (11), and has a value in the range of from 200 micrometers to 450 micrometers along a second physical direction, which is oriented transversely with respect to the longitudinal direction of the electrode (11) and at right angles to the first physical direction.

6. The electrode as claimed in claim 1, characterized in that the electrode (11) consists of tungsten, a tungsten alloy or of tungsten provided with dopants.

7. The electrode as claimed in claim 6, characterized in that a section of the shaft is provided with a coating which contains ruthenium.

8. A discharge lamp having at least one electrode as claimed in one or more of claims 1 to 7.

9. The discharge lamp as claimed in claim 8, characterized in that the discharge vessel (10) consists of quartz glass and has at least one molybdenum foil seal, the shaft (11a) of the at least one electrode (11) being connected to a molybdenum foil (103) of the at least one molybdenum foil seal.

10. The electrode as claimed in claim 2, characterized in that the dimension of the shaft (11a) has a value in the range of from 50 micrometers to 350 micrometers along a first physical direction, which is oriented transversely with respect to the longitudinal direction of the electrode (11), and has a value in the range of from 200 micrometers to 450 micrometers along a second physical direction, which is oriented transversely with respect to the longitudinal direction of the electrode (11) and at right angles to the first physical direction.

11. The electrode as claimed in claim 3, characterized in that the dimension of the shaft (11a) has a value in the range of from 50 micrometers to 350 micrometers along a first physical direction, which is oriented transversely with respect to the longitudinal direction of the electrode (11), and has a value in the range of from 200 micrometers to 450 micrometers along a second physical direction, which is oriented transversely with respect to the longitudinal direction of the electrode (11) and at right angles to the first physical direction.

12. The electrode as claimed in claim 4, characterized in that the dimension of the shaft (11a) has a value in the range of from 50 micrometers to 350 micrometers along a first physical direction, which is oriented transversely with respect to the longitudinal direction of the electrode (11), and has a value in the range of from 200 micrometers to 450 micrometers along a second physical direction, which is oriented transversely with respect to the longitudinal direction of the electrode (11) and at right angles to the first physical direction.
